(19) United States
(12) Patent Application Publication
(10) Pub. No.: US 2013/0025126 A1
(43) Pub. Date: Jan. 31, 2013

(54) Tire Press

(71) Applicant: Martin A. Medley, Bradenton, FL (US)

(72) Inventor: Martin A. Medley, Bradenton, FL (US)

(21) Appl. No.: 13/559,069

(22) Filed: Jul. 26, 2012

Related U.S. Application Data
(60) Provisional application No. 61/511,732, filed on Jul. 26, 2011.

(51) Int. Cl. B60C 25/00; B23P 19/04

(52) U.S. Cl. 29/894.3; 29/281.3; 29/426.6

(57) ABSTRACT

A tire press is provided for inserting or removing a variable function insert (VFI) from a tire that includes a frame, a jaw assembly secured to the frame and a pusher assembly secured to the frame for interaction with the jaw assembly to insert or remove the VFI from within the tire. The invention also includes the method of inserting or removing the VFI from the tire using the press.

### CROSS-REFERENCE TO RELATED APPLICATIONS

This application claims priority from U.S. Provisional Application Ser. No. 61/511,732, filed on Jul. 26, 2011, the entirety of which is hereby expressly incorporated by reference herein.

### FIELD OF THE INVENTION

The present invention relates generally to tires and more particularly to a press for use in assembling and disassembling run flat tires.

### BACKGROUND OF THE INVENTION

In order to lessen the dangers associated with a tire on a vehicle going flat during operation of the vehicle, a number of different devices have been developed. One of these devices is an insert positioned within the tire, such as variable function insert (VFI).

In normal operation, if a tire on a vehicle goes flat the tire loses the air inside the tire, eliminating further traction and mobility, such that travel of the vehicle will halt shortly after losing the air from within the tire. The primary reason for this is that the weight of the vehicle is carried through the wheels, which drops the wheel flange onto the deflated tire crushing the tire between the ground and the wheel flange. As a result, the tire will not roll anymore because the tire is flat and not round.

Furthermore, the tire bead or edge of the tire will not stay attached to the wheel flange because the power transfer of the vehicle drive-train through the wheel will cause tire bead to separate from the wheel flange. The remaining inflated tires may still provide traction, allowing the vehicle to travel further. However, this movement of the vehicle will cause the flat tire wheel flange to roll over the tire sidewall and cut the tire off the wheel.

Looking now at FIG. 1., the VFI is an solid insert formed of a resilient material, such as a relatively hard rubber, capable of supporting a significant amount of weight, such as that of a motor vehicle, while also being able to deflect a desired amount under that amount of weight. As shown in FIG. 1, the VFI 1000 is formed with a shape that is complementary to, but smaller than that of a tire 1002, such that the VFI 1000 can be fully positioned within the interior of the tire 1002 when the tire 1002 is disposed on a vehicle wheel or rim 1004 without interfering with the normal operation of the tire 1002 when the tire 1002 is properly inflated. However, when the tire 1002 in which the VFI is positioned goes flat, the VFI 1000 provides a structure within the tire 1002 that prevents the tire 1002 from completely collapsing under the weight of the vehicle. As a result, the VFI 1000 to supports the vehicle in a manner that enables the vehicle to continue to be operated and moved until a suitable location is reached where the tire 1002 and VFI 1000 can be removed and repaired or replaced.

In particular, the benefits provided by a VFI 1000 positioned within the interior 1001 of a tire 1002, when the tire 1002 deflates after being damaged, include that the solid rubber VFI 1000 keeps the vehicle wheel flange 1006 suspended away from the ground, not allowing the weight of the vehicle to pinch the tire sidewall 1008 between the ground surface and wheel flange 1006, that the vehicle can continue its movement for hours or days without repair while traveling on the solid rubber VFI 1000, which is still attached to, i.e., disposed around the wheel 1004 within the tire 1002, which remains attached to the vehicle wheel 1004, and that the weight of the vehicle operates to compress the VFI 1000 securely against the tire bead 1010, thereby pinching the tire bead 1010 between the wheel flange 1006 and the VFI 1000 to maintain the tire 1002 on the wheel 1004.

However, due to the nature of the material forming the VFI, in order to enable the VFI to function as intended, the insertion and removal of the VFI from the interior of the tire requires a significant amount of force.

Thus, it is desirable to develop a device that is capable of inserting and removing a VFI from the interior of a wheel.

### SUMMARY OF THE INVENTION

Briefly described, one aspect of the present invention provides a press for assembling or disassembling a run flat tire including a VFI therein. The press includes frame on which is disposed a tire gripping mechanism and an insertion/extraction cylinder. The tire can be positioned on the frame using a lifting apparatus affixed to the frame and engaged by the gripping mechanism to hold the tire on the press. The insertion/extraction cylinder is then operated in order to position a VFI within the tire or to remove a VFI from a tire.

Numerous other aspects, features, and advantages of the present invention will be made apparent from the following detailed description together with the drawings figures.

### BRIEF DESCRIPTION OF THE DRAWINGS

The drawings illustrate the best mode currently contemplated of practicing the present disclosure.

In the drawings:

FIG. 1 is a cross-sectional view of a tire including a VFI positioned therein;

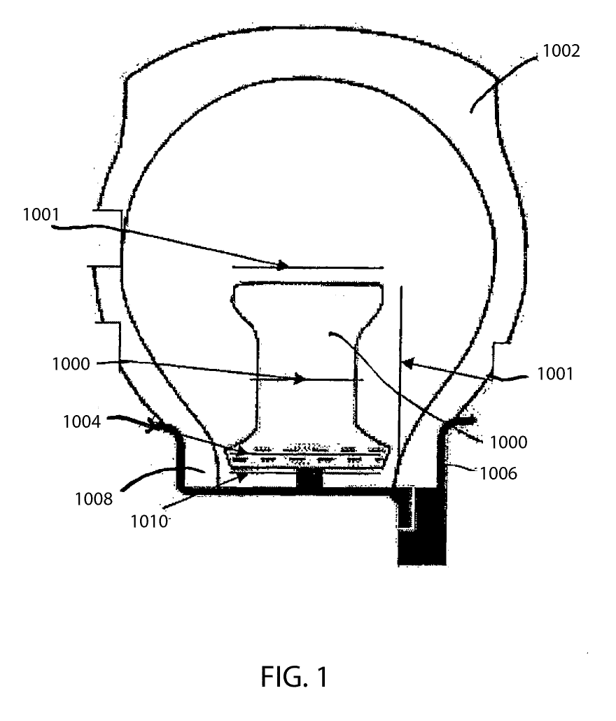

FIG. 2 is a front isometric view of a tire press constructed according to the present disclosure in an open, retracted position;

FIG. 3 is a front isometric view of the press of FIG. 2 in an open engaged position;

FIG. 4 is a bottom isometric view of the press of FIG. 3;

FIG. 5 is a front isometric view of the press of FIG. 2 in a closed, retracted position;

FIG. 6 is a bottom isometric view of the press of FIG. 5;

FIG. 7 is a front isometric view the press of FIG. 2 in a closed, engaged position;

FIG. 8 is a rear isometric view of the press of FIG. 7;

FIG. 9 is a side plan view of a pusher rod of the press of FIG. 2;

FIG. 10 is a top isometric view of an extraction rod for use with the press of FIG. 2; and

FIG. 11 is a top isometric view of a jaw and guide rod assembly of the press of FIG. 2.

### DETAILED DESCRIPTION OF THE INVENTION

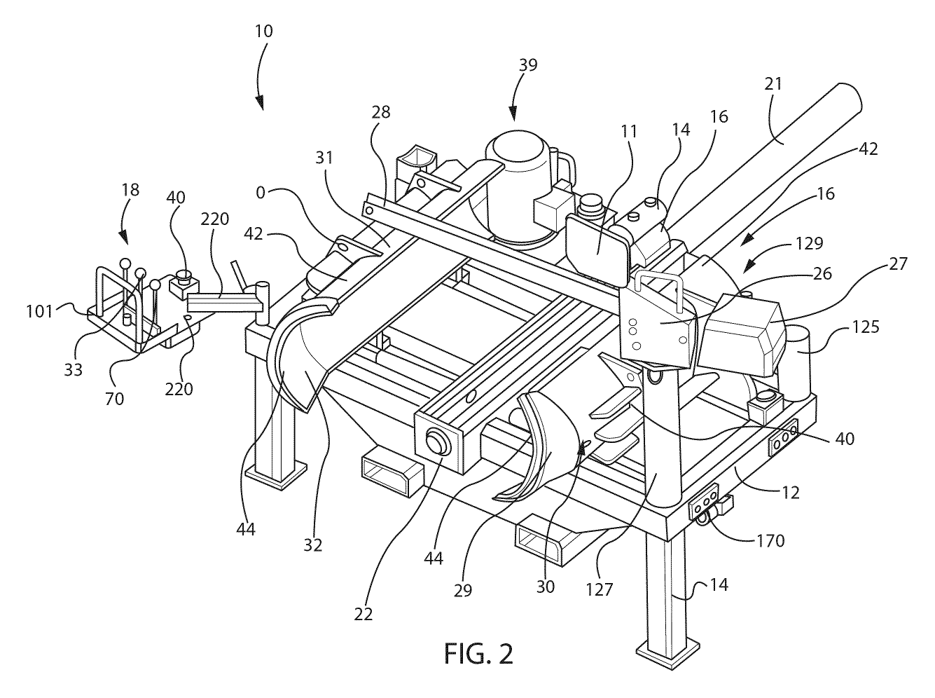

Referring now in detail to the drawing figures, wherein like reference numerals represent like parts throughout the several views, one embodiment of a press constructed according to the present disclosure is illustrated generally at 10 in FIG. 2. The press 10 includes a frame 12 having a number of legs 14 extending downwardly therefrom in order to support the press 10 on a surface, such as a floor.

In general, the frame 12 supports a jaw assembly 16, a hydraulic unit 39, a crane assembly 129 and a controller 18. The jaw assembly 16 includes a right jaw 31 and a left jaw 30. Each jaw 30,31 has a curved shape and is operably connected to a guide assembly 19 and a jaw cylinder 60 that is operably connected to the hydraulic unit 130.

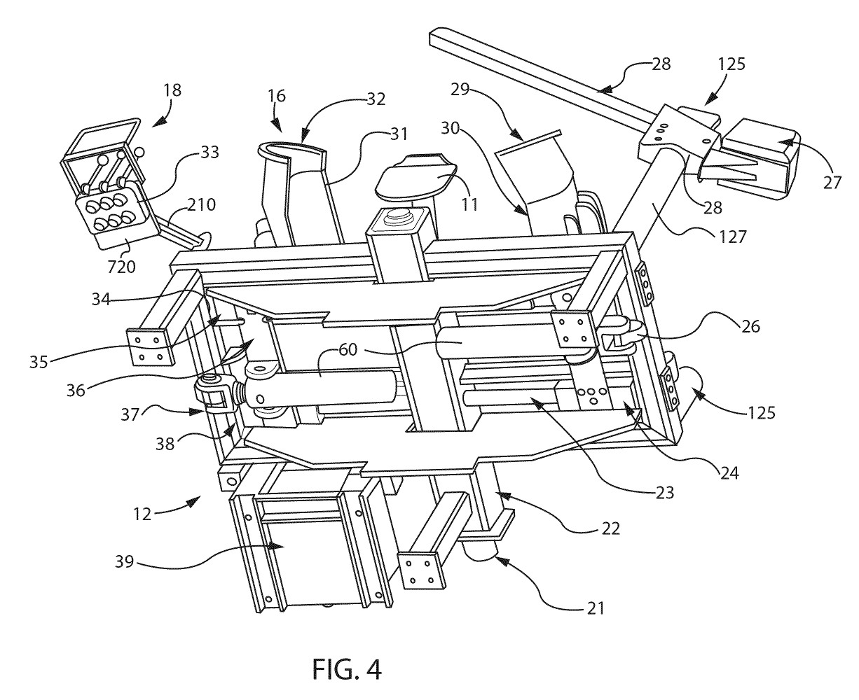

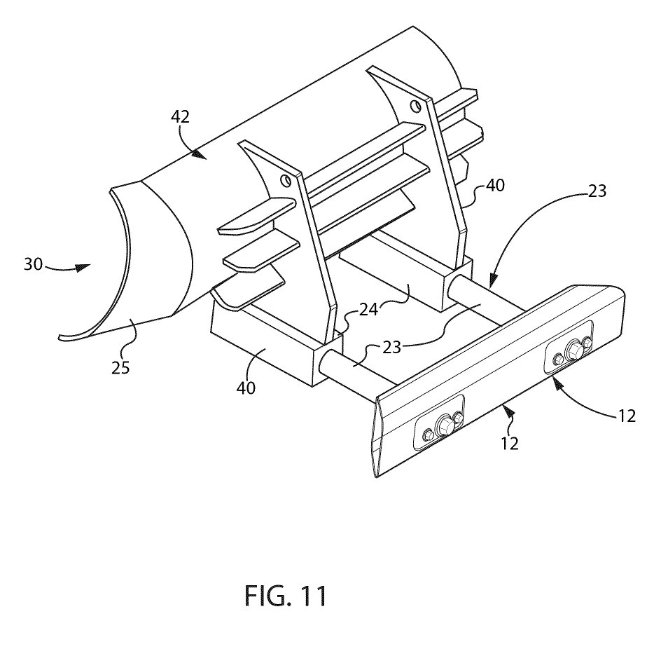

As best shown in FIGS. 4 and 11, the guide assembly 22 for each jaw 30, 31 includes a number of guide rods 23 disposed in channels 34 formed in the frame 12 and connected between the jaw 30, 31 and the frame 12, a guide bushing 24 disposed around and slidable with respect to each rod 23 and a number of mounting plates 40 and reinforcing ribs 40a connecting the guide bushings 24 to the jaws 30, 31. In the illustrated embodiment, two rods 23 and bushings 24 are utilized, but additional or fewer rods 23 and bushings 24 can be employed depending upon the strength required for the jaw assembly 16.

The jaws 30, 31 each have a main body 42, which in the illustrated embodiment is generally arcuate in shape in order to readily engage and hold a tire 1002 when in use, and an inwardly tapering or extending nose 29, 32, respectively, that terminate in a rim 44 that extends outwardly at an angle with respect to the nose guides 29, 32, and perpendicular to the nose 29, 32 in the illustrated embodiment. Also, in the illustrated embodiment, the nose guides 29, 32 are fixed to, such as by welding, or formed integrally with the main body 42. However, the noses 29, 32 can be formed to be releasably attached to the main body 42, in order to enable noses 29, 32 with different configurations for different tires 1002 to be utilized on the jaws 30, 31.

The noses 29, 32 are adapted be positioned within the center of the tire 1002 such that the outwardly extending rim 44 on each nose 29,32 can engage and hold the tire 1002 thereon during various stages of the insertion or removal of the VFI 1000 using the press 10. Further, the jaws 30,31 are readily removable from the press 10 and replaced by other jaws (not shown) or for use on other presses (not shown) making the press 10 and the jaws 30,31 interchangeable with one another. In addition, the jaws 30, 31 are designed to be able to insert and extract VFIs 1000 that would break prior art jaw constructions. This is due in part to the construction of the jaws 30, 31 which includes the configuration for the jaws 30, 31 including the guide bushings 24 and the mounting plates 40 and ribs 40a which provides added strength to the jaws 30, 31 when in operation. In addition, floor pans 35 are disposed across the frame 12 over and between the guide rods 24 to provide a support surface on the frame 12 around the jaws 30, 31.

Looking now at FIG. 4, between the guide rods 24 is disposed a connecting plate 36. The plate 36 connects the bushings 24 to one another to ensure that the bushings 24 connected to the jaws 30, 31 move in conjunction with one another to control the movement of the entire jaw 30, 31 in a uniform manner. The plates 36 are also connected to the corresponding jaw cylinder 60 disposed in the illustrated embodiment below the plates 36 in an horizontal, offset position from one another using a pair of flanges 62 disposed on opposed sides of the cylinder 60, which reduces the footprint of the assembly 22 and the overall press 10. A rod 38 extends outwardly from the cylinder 60 and is attached to a stop 26 on the frame 12 via a U-shaped clevis 37. The cylinders 60 are operably connected to the hydraulic unit 39 which supplies the pressurized hydraulic fluid to the cylinders 60 required for their operation.

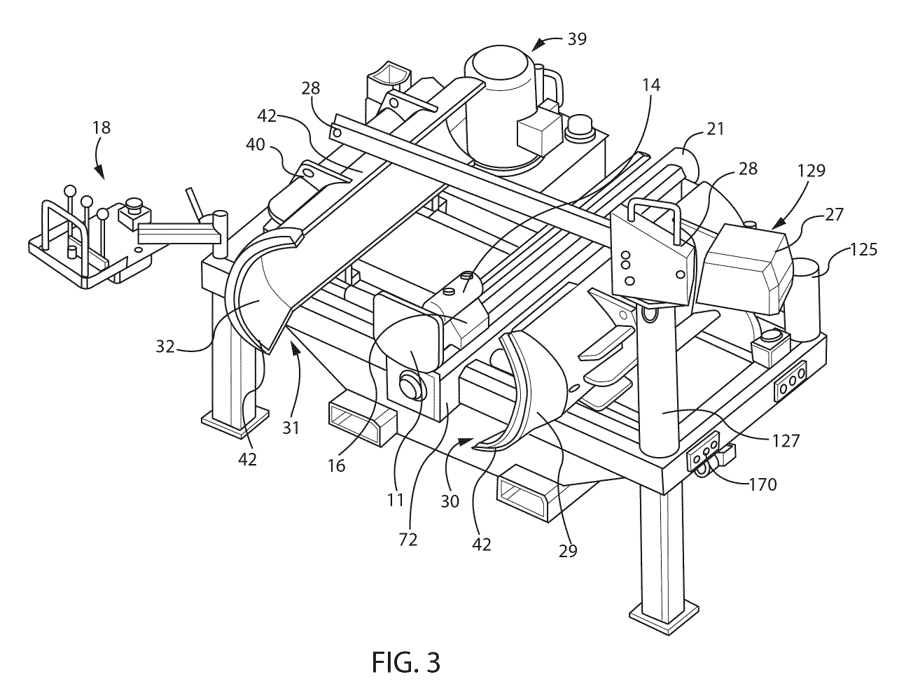

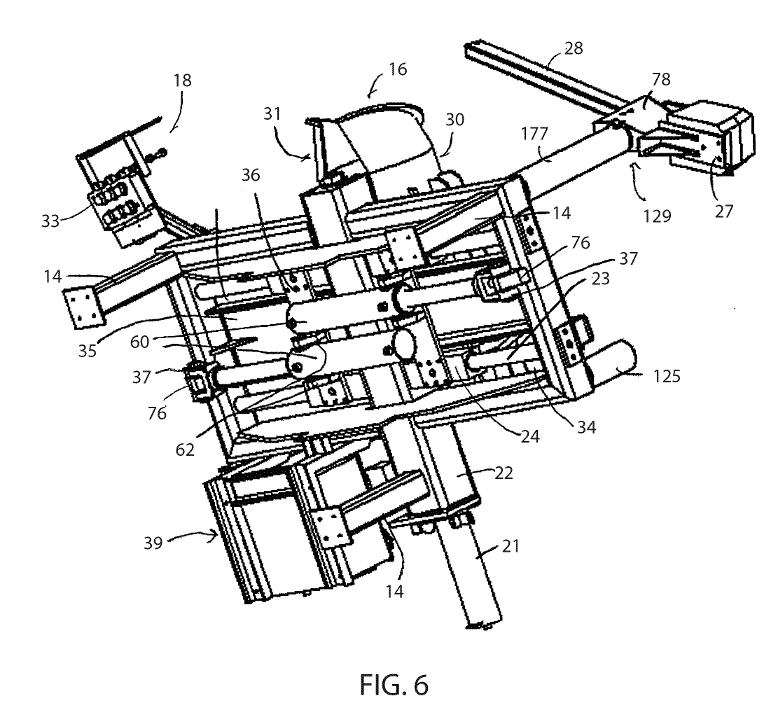

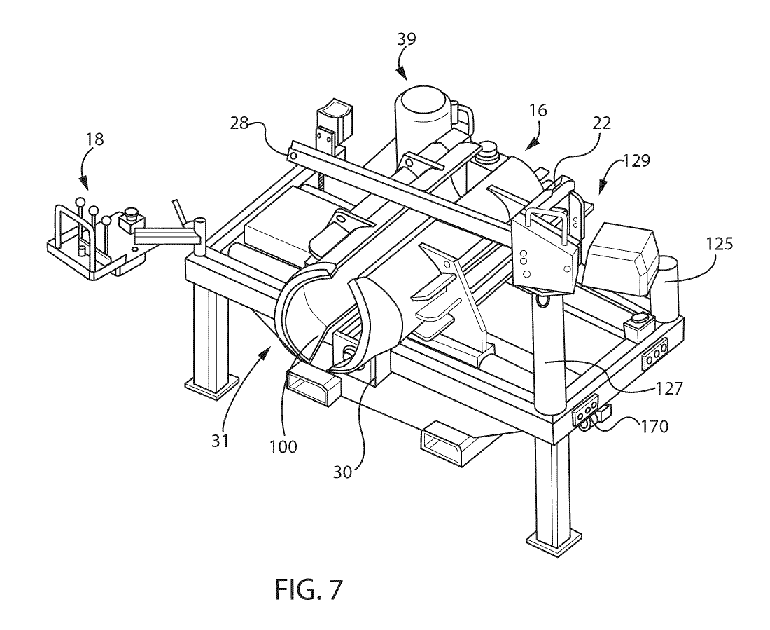

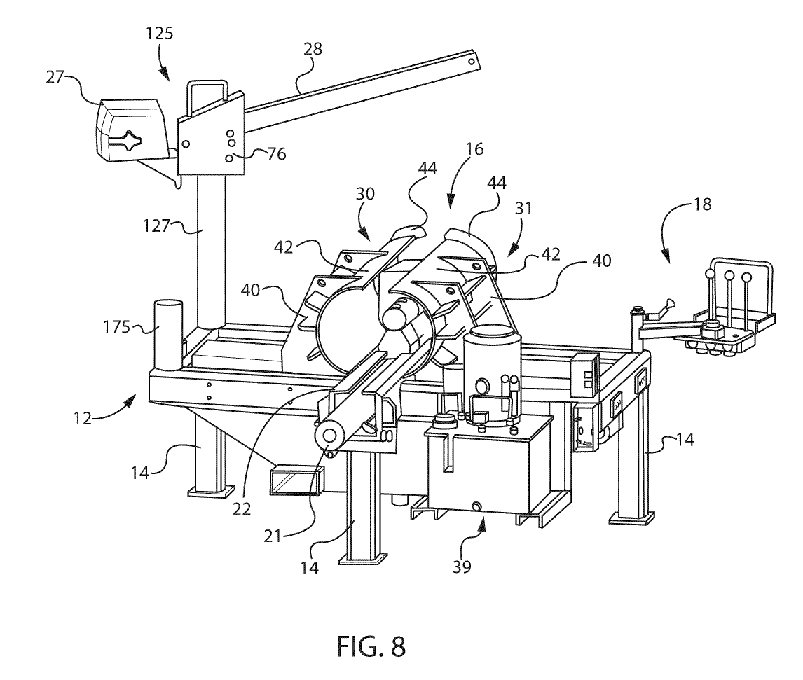

When the cylinder 60 is operated to move the rod 38 out of the cylinder 60, the attachment of the rod 38 to the frame 12 causes the cylinder 60 to move the associated connecting plate 36 and consequently the bushings 24 along the guide rods 23, thereby moving the jaws 30,31 to the various positions shown in FIGS. 2-8.

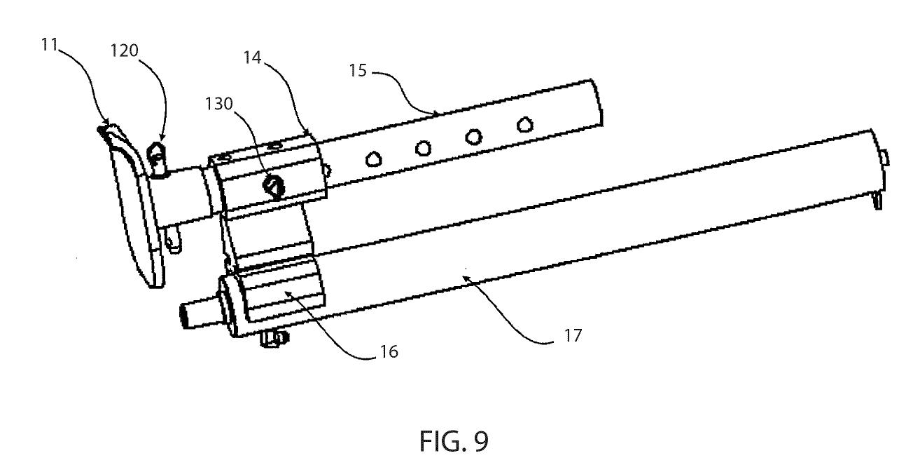

Looking now at FIGS. 2-9, on the frame 12 and between the jaws 30,31 is disposed a pusher cylinder 21 that is operably connected to the hydraulic unit 39 and secured to the frame 12 within a guide tube channel 22 positioned between the jaws 30,31. As best shown in FIG. 9, an engagement member, such as a pusher nose plate 11, is secured to an extension arm 17, which can be a telescoping arm, affixed to the end of the cylinder 21 and disposed above the channel 22 on the frame 12 by a pin 120 releasably engaged between the plate 11 and an adaptor rod 15. The rod 15 can be repositioned with respect to the cylinder 21 and extension arm 17 by movement of the adaptor rod 15 within a sleeve 16 secured to the end of the arm 17. The rod 15 includes a number of apertures therein that are selectively aligned with an opening in a rod channel 14 on the sleeve 16 and secured thereto by a pin 130. The adaptor rod 15 and pin 120 connects the plate 11 to the cylinder 21, such that the plate 11 can be moved by the operation of the cylinder 21 in a direction generally perpendicular to the movement of the jaws 30, 31.

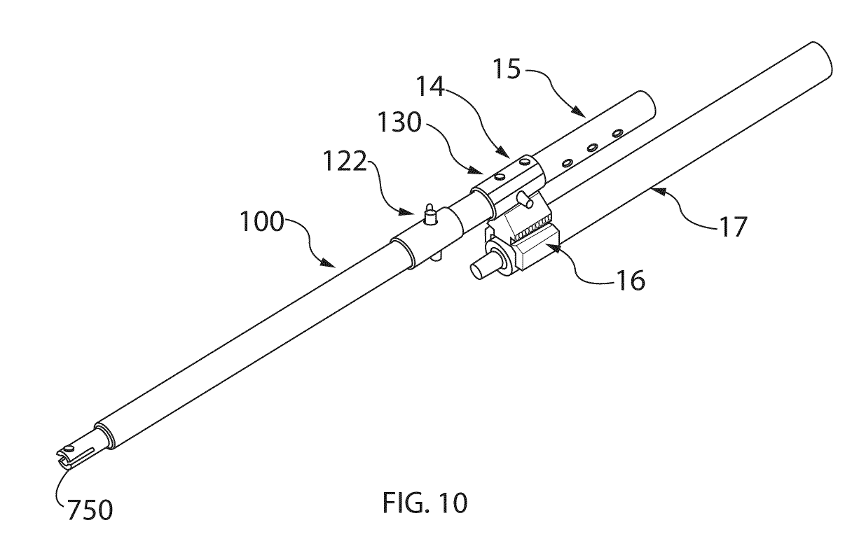

Referring now to FIG. 10, the pin 120 can be removed from the rod 15 to enable the pusher plate 11 to be removed from the rod 15 to enable a different engagement member, such as an extractor arm 100, to be affixed to the rod 15. The extractor 100 includes a slot 250 at one end that receives a pin (not shown) similar to pin 120 perpendicularly therethrough to enable the extractor 100 to be utilized with a strap (not shown) attached at each end within the slot 250 by the pin to remove a VFI 1000 from within a tire 1002, as will be discussed.

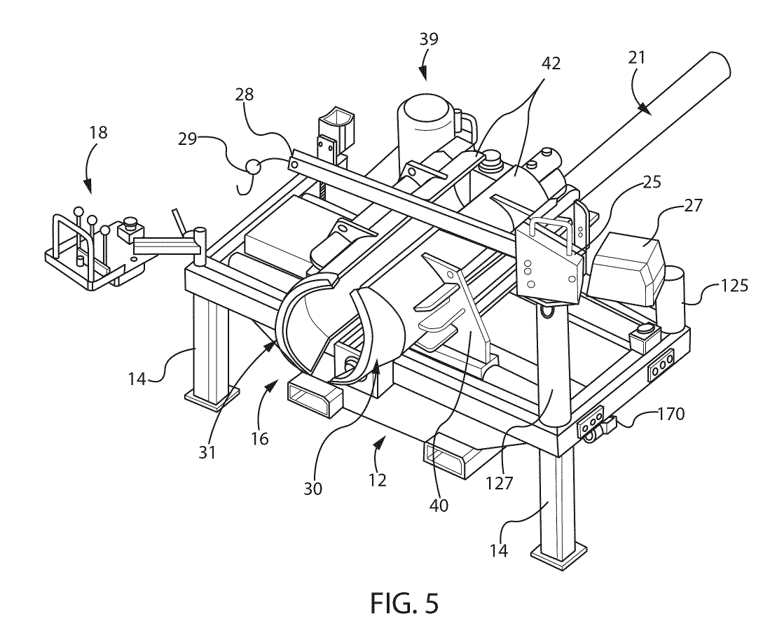

As shown in FIGS. 5-8, the frame 12 also supports a crane assembly 129 which is pivotally secured to the frame 12 and includes a cable housing 260, a motor housing 270, a boom 280, and a cable/hook assembly 290. The motor (not shown) disposed within the motor housing 270 can be operably connected to a power source by a receptacle 170 disposed on the frame in order to operate the crane assembly 129. The crane assembly 129 can be positioned on the frame 12 in either of a pair of mounting sleeves 125, during transportation of the press 10, and 127, when the press 10 and crane 129 are deployed or in operational mode, that are disposed at adjacent corners of the frame 12. In the transport or storage configuration for the press 10, each of the components of the press 10 remains mounted to the frame 12, but within the dimensions of the frame 12 in order to minimize the length and width footprint of the press 10 in the transport or storage configuration. Also, the frame includes tubes 90 that are engaged with the forks of a forklift (not shown) in order to enable the press 10 to be readily moved.

The hydraulic unit 39 and the various cylinders 21, 60 and motors are controlled by the operation of the controller 18 that includes hydraulic controls 33 disposed on a control bracket 101 movably secured to the frame 12. The controls 33 are positioned adjacent a stop switch 40 and a motor starter 20, secured to the frame 12 by a standoff 210 and plate 220, in order to control the operation of the press 10.

When the press 10 is in operation to insert a VFI 1000 within a tire 1002, initially the jaws 30, 31 and channel 22 are lubricated to ensure smooth movement of the components of the press 10, and the nose plate 11 is drawn to a rearmost position on the frame 12. The VFI 1000 is then lifted onto the frame 12 by the crane 129 and positioned between the jaws 30, 31. The jaws 30, 31 are then operated to engage and squeeze the VFI 1000 until the circular space within the circular VFI 1000 is closed. The curved shape of the main body 42 of each jaw 30, 31 serves to retain the VFI 1000 between the jaws 30, 31 as it is compressed. The tire 1002 is then raised by the crane 129, such as by using a hook (not shown) engaged with the tire bead 1010, to place the tire 1002 around the jaw nose guides 29 and 32. The jaws 30, 31 are then opened slightly to engage the interior circumference of the tire 1002 to hold the tire 1002 on the press 10. Once engaged, the cylinder 21 is operated to move the nose plate forward to push the compressed VFI 1000 into the interior of the tire 1002.

Additionally, when the press 10 is operated to remove a VFI 1000 from within a tire 1002, initially the nose plate 11 is removed and the extractor 100 is attached to the rod 15. The jaws 30, 31 are then moved to the closed position and the tire 1000 including the VFI 1002 is moved onto the nose 29, 32 of the jaws 30, 31 using the crane 129. The jaws 30, 31 are then expanded to engage the central opening in the tire 1002 to hold the tire 1002 on the press 10. A strap (not shown) is then wrapped around the VFI 1000 within the tire 1002 and the opposed ends of the strap are engaged within the slot 250 of the extractor 100 by the pin. The cylinder 21 is then operated to move the extractor 100 away from the frame 10 through the central opening in the tire 1002 to draw the VFI 1000 out of the tire 1002. If the extractor rod 100 is not long enough to draw the entire VFI 1000 out of the tire 1002, it may be necessary to disengage and reposition the extractor rod 100 to fully extract the VFI 1000. Once extracted, the VFI 1000 is removed from the extractor rod 100 and the tire 1002 is moved off of the press 10 by the crane 129.

Various other embodiments of the present invention are contemplated as being within the scope of the filed claims particularly pointing out and distinctly claiming the subject matter regarded as the invention.

1. A tire press utilized for insertion or removal of a variable function insert (VFI) from a tire, the tire press comprising:
a) a frame;
b) a jaw assembly secured to the frame; and
c) a pusher assembly secured the frame for interaction with the jaw assembly.

2. The tire press of claim 1 further comprising a crane assembly secured to the frame adjacent the jaw assembly.

3. The tire press of claim 1 wherein the jaw assembly comprises a pair of moveable jaws.

4. The tire press of claim 3 wherein each jaw includes at least one guide assembly for controlling the movement of the jaw on the frame.

5. The tire press of claim 4 wherein the at least one guide assembly includes a guide bushing connected to the jaw and slidably disposed around a guide rod connected to the frame.

6. The tire press of claim 3 wherein each jaw comprises:
a) a main body secured to the frame; and
b) an inwardly tapering nose at one end.

7. The tire press of claim 6 wherein each jaw further comprises an outwardly extending rim disposed on the nose opposite the main body.

8. The tire press of claim 3 wherein the main body and nose are generally arcuate in shape.

9. The tire press of claim 3 wherein the pusher assembly is disposed on the frame between the jaws and is configured to move perpendicularly to the movement of the jaws.

10. The tire press of claim 9 wherein the pusher assembly comprises:
a) an extension arm movably secured to the frame; and
b) an engagement member secured to the extension arm.

11. The tire press of claim 10 wherein the engagement member is a nose plate.

12. The tire press of claim 10 wherein the engagement member is an extractor arm.

13. The tire press of claim 10 wherein the pusher assembly further comprises a hydraulic cylinder operably connected to the extension arm to move the extension arm with respect to the frame.

14. A method of inserting or extracting a variable function insert (VFI) from a tire, the method comprising the steps of:
a) providing the tire press of claim 1;
b) enagaging the tire and the VFI with the press; and
c) operating the press to remove the VFI from the tire.

15. A method of inserting a variable function insert (VFI) into a tire, the method comprising the steps of:
a) providing the tire press of claim 1;
b) enagaging the tire and the VFI with the press; and
c) operating the press to insert the VFI within the tire.
